(19) United States
(12) Patent Application Publication
(10) Pub. No.: US 2004/0169981 A1
(43) Pub. Date: Sep. 2, 2004

(54) Current limiting circuit

(76) Inventors: Andy Werback, San Jose, CA (US); Nhan Nguyen, San Jose, CA (US); James Beninghaus, Campbell, CA (US)

Correspondence Address: Mitchell S. Feller, Hogan & Hartson, L.L.P., 875 Third Avenue, New York, NY, 10022, US

(21) Appl. No.: 10/664,844

(22) Filed: Sep. 17, 2003

Related U.S. Application Data
(60) Provisional application No. 60/412,151, filed on Sep. 19, 2002.

(51) Int. Cl. H02H 3/08; H02H 5/04

(52) U.S. Cl. 361/93.9; 361/93.1; 361/31

(57) ABSTRACT

A circuit is provided for limiting the in-rush current of a radio device coupled to a low-power external power source and includes a switch circuit in series between the power source and the radio device, the switch having an “off” state with a high impedance and an “on” state with a low impedance. Also included is a time-delay shorting circuit coupled to the switch circuit, the time-delay shorting circuit having a time constant. In operation, before the time constant elapses, the switch circuit is in the high impedance “off” state for limiting the in-rush current to the radio device and after the time constant elapses, the switch circuit is in the low impedance “on” state so that the radio device is powered by the external power source.

### CROSS-REFERENCE TO RELATED APPLICATION

This application claims the benefit of the filing date of U.S. Provisional Application serial No. 60/412,151 entitled “Current Limiting Circuit” that was filed on Sep. 19, 2002, the contents of which are incorporated by reference herein.

### FIELD OF THE INVENTION

The following invention relates to a radio device for use in handheld computing devices and, in particular, to a Compact Flash™ radio device that operates according to the power capabilities of low-power handheld computing devices.

### BACKGROUND

Personal digital assistants (PDAs) are an increasingly popular and useful computing platform. PDAs are typically handheld devices that run a variety of productivity software (e.g., address book, calendaring etc.), business applications (e.g., spreadsheets, word processing), communications applications (e.g., email, web browser) as well as many other types of applications. While a prime advantage of PDAs is to provide a user with a mobile computing resource, many PDA applications (for example, email) require a periodic connection to a user's desktop computer for data exchange and network connectivity. Although most PDAs can be physically attached to a cradle that is connected to a desktop computer for transferring data between the PDA and the desktop computer, it is often more desirable (and consistent with the PDA as a mobile computing resource) to provide desktop and network connectivity wirelessly. As a result, many add-on devices are available for PDAs to provide wireless connectivity using various protocols, such as Bluetooth and 802.11.

Add-on devices for PDAs come in a variety of sizes and form-factors. The most desirable devices are those that are the smallest and that add the least weight to the PDA. An increasingly popular form-factor for PDA add-on devices is the Compact Flash™ (the registered trademark of SanDisk Corporation) form-factor which results in small and lightweight add-on devices that fit in most PDA expansion slots. Typical add-ons that come in a Compact Flash form-factor include memory expansion, storage and flash-based software applications. It is also desirable to provide various radio devices in the Compact Flash form-factor to provide PDA users with wireless connectivity via Bluetooth, 802.11 or other wireless protocols.

A problem with incorporating radio devices in a Compact Flash form-factor for use in handheld PDAs is that the conventional design of a high density/high performance radio device has a very high in-rush current at the time of device power up. For example, the ASICs of a typical 802.11 device can require an in-rush current up to 4 amps when the device is first powered up. In contrast, PDAs (the target platform for the Compact Flash-based radio device) are typically low-power devices that support less than 200 ma continuously. As a result, a Compact Flash™ radio device using existing circuit designs will exceed the capabilities of the power supply of the PDA and activate power supply protection features causing the radio to fail resulting and/or operate.

One approach for overcoming the high in-rush current problem is to include a higher capacity power source in the PDA itself. While this may be possible in some cases, this approach would have the undesirable consequence of increasing the size and weight of the PDA. Another approach for overcoming the in-rush current problem is to include a power source in the radio device itself. While this approach may be suitable for certain types of radio devices, it is not suitable for Compact Flash™ radio devices that are required to be powered externally.

Accordingly, it is desirable to provide a Compact Flash radio device that operates within to the power capabilities of low-power handheld computing devices.

### SUMMARY OF THE INVENTION

The present invention is directed to overcoming the drawbacks of the prior art. Under the present invention, a circuit is provided for limiting the in-rush current of a radio device coupled to a low-power external power source. The current limiting circuit includes a switch circuit in series between the power source and the radio device, the switch having an “off” state with a high impedance and an “on” state with a low impedance. Also included is a time-delay shorting circuit coupled to the switch circuit, the time-delay shorting circuit having a time constant. In operation, when the circuit is initially powered, the switch circuit is in the high impedance “off” state and acts to limit the in-rush current to the radio device. As the time constant elapses, the switch circuit changes to its low impedance “on” state so that the radio device is fully powered by the external power source.

In an exemplary embodiment, the switch circuit includes a field effect transistor having an “on” state resistance being in parallel with an in-rush current limiting resistor having a resistance, wherein the high impedance is substantially the resistance of the in-rush current limiting resistor and the low impedance is substantially the on resistance of the field effect transistor.

In an exemplary embodiment, the “on” state resistance of the field effect transistor is in the range of about 0.05 to about 0.2 ohms.

In a more preferred embodiment, the “on” state resistance of the field effect transistor is approximately 0.1 ohms.

In an exemplary embodiment, the resistance of the in-rush current limiting resistor is in the range of about 5 to about 10 ohms.

In a more exemplary embodiment, the resistance of the in-rush current limiting resistor is approximately 5 ohms.

In a specific embodiment, the “on” state resistance of the field effect transistor is approximately 0.1 ohms and the resistance of the in-rush current limiting resistor is approximately 5 ohms.

The time-delay circuit can include a capacitor and a resistor, the capacitor having a first end coupled to the external power supply and a second end coupled to the field effect transistor and wherein the capacitor has a capacitance and the resistor has a resistance selected to provide the desired time constant. In an exemplary embodiment, the time constant is in the range of 2 to 3 milliseconds.

In an exemplary embodiment, the radio device is provided in a Compact Flash™ form factor and the low-power external power source is provided in a handheld computing device and wherein the radio device is coupled to the handheld computing device.

Under the present invention, a method is provided for limiting the in-rush current of a radio device coupled to a low-power external power source and includes the steps of inserting a switch circuit in series between the power source and the radio device, the switch having an “off” state with a high impedance and an “on” state with a low impedance, coupling a time-delay shorting circuit to the switch circuit, the time-delay shorting circuit having a time constant, switching the switch to the high impedance “off” state is switched to limit the in-rush current to the radio device before the time constant has elapsed and then switching the switch to the low impedance “on” state after the time constant has elapsed so that the radio device is powered by the external power source.

In another embodiment, a radio device is provided in a Compact Flash™ form factor, the radio device being powered by a low-power external power source, and including radio electronics having an in-rush current demand on power-up. Also included is a switch circuit in series between the power source and the radio device, the switch circuit having an “off” state with a high impedance and an “on” state with a low impedance. A time-delay shorting circuit coupled to the switch circuit is included, the time-delay shorting circuit having a time constant. In operation, before the time constant elapses, the switch circuit is in the high impedance “off” state for limiting the in-rush current to the radio device and after the time constant elapses, the switch circuit is in the low impedance “on” state so that the radio device is powered by the external power source.

A further aspect of the invention provides a method for limiting the in-rush current of a radio device coupled to a low-power external power source that includes the steps of initially charging the radio device with a power source in a low power state; sensing a voltage across a component associated with said radio device and switching from said low power state to a full power state when said voltage exceeds a threshold level.

The present invention thus advantageously provides a radio device that operates according to the power capabilities of low-power handheld computing devices and that is particularly well-suited for use in a Compact Flash™ form factor.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is a block diagram of a handheld computing device configured to receive a Compact Flash radio device in accordance with the present invention;

FIG. 2 is a schematic of an in-rush limiting circuit used in the Compact Flash radio device of FIG. 1 in accordance with a first embodiment of the present invention;

FIG. 3 is a schematic of an in-rush limiting circuit used in the Compact Flash radio device of FIG. 1 in accordance with a second embodiment of the present invention;

FIG. 4A is a schematic of an in-rush limiting circuit used in the Compact Flash radio device of FIG. 1 in accordance with a third embodiment of the present invention;

FIG. 4B is a schematic of an in-rush limiting circuit used in the Compact Flash radio device of FIG. 1 in accordance with a fourth embodiment of the present invention;

FIG. 5 is a schematic of an in-rush limiting circuit used in the Compact Flash radio device of FIG. 1 in accordance with a fifth embodiment of the present invention;

FIG. 6A is a schematic of an in-rush limiting circuit used in the Compact Flash radio device of FIG. 1 in accordance with a sixth embodiment of the present invention;

FIG. 6B is a schematic of an in-rush limiting circuit used in the Compact Flash radio device of FIG. 1 in accordance with a seventh embodiment of the present invention;

FIG. 7 is a schematic of an in-rush limiting circuit used in the Compact Flash radio device of FIG. 1 in accordance with a eighth embodiment of the present invention;

FIG. 8 is a schematic of an in-rush limiting circuit used in the Compact Flash radio device of FIG. 1 in accordance with a ninth embodiment of the present invention;

FIG. 9A is a schematic of an in-rush limiting circuit used in the Compact Flash radio device of FIG. 1 in accordance with a tenth embodiment of the present invention;

FIG. 9B is a schematic of an in-rush limiting circuit used in the Compact Flash radio device of FIG. 1 in accordance with a eleventh embodiment of the present invention;

FIG. 10 is a schematic of an in-rush limiting circuit used in the Compact Flash radio device of FIG. 1 in accordance with a twelfth embodiment of the present invention;

FIG. 11A is a schematic of an in-rush limiting circuit used in the Compact Flash radio device of FIG. 1 in accordance with a thirteenth embodiment of the present invention; and

FIG. 11B is a schematic of an in-rush limiting circuit used in the Compact Flash radio device of FIG. 1 in accordance with a fourteenth embodiment of the present invention.

### DETAILED DESCRIPTION OF THE PREFERRED EMBODIMENTS

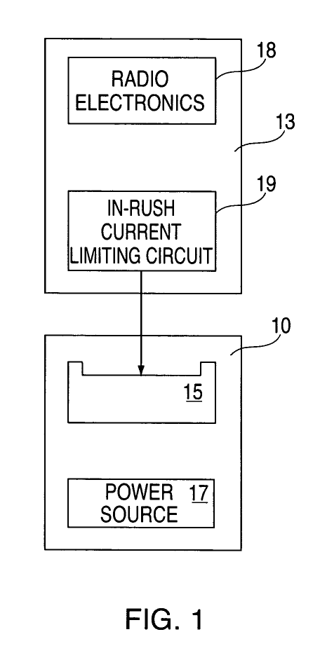

Referring now to FIG. 1, there is shown a handheld computing device 10 configured to receive a Compact Flash radio device 13 in accordance with the present invention. Handheld computing device 10 may be, by way of non-limiting example, a personal digital assistant (PDA) such as provided by Palm, Inc. of Milpitas Calif., Compaq Computer Corporation of Houston Tex. as well as numerous others. Handheld computing device 10 includes an expansion slot 15 for receiving expansion devices, such as additional memory, storage and radio devices. Expansion slot 15 may be designed to receive expansion devices having any form factor including, by way of non-limiting example, a Compact Flash form factor. Handheld computing device 10 also includes a power source 17 for power device 10 as well as any expansion devices inserted in expansion slot 15.

Also shown in FIG. 1 is a radio device 13 designed for insertion into expansion slot 15 of device 10. In an exemplary embodiment, radio device 13 is designed to conform with the Compact Flash form factor. Radio device 13 may support any type of wireless communications protocol standard such as Bluetooth and 802.11. In order to support wireless communications, radio device 13 includes the appropriate radio electronics 18 (designed in accordance with known techniques) that implement the communications protocols for the desired standard. Also included in radio device 13 is an in-rush current limiting circuit 19 according to the invention and which is described in detail below.

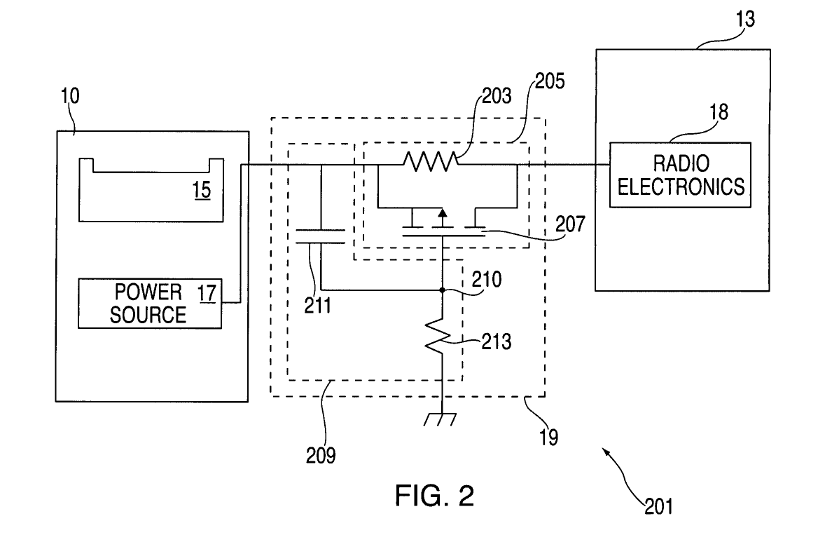

Referring now to FIG. 2, there is shown a schematic 201 of in-rush limiting circuit 19 of FIG. 1. Elements that are similar to elements included in FIG. 1 are identically labeled and a detailed description thereof is eliminated.

Circuit 19 includes a switch circuit 205 that includes an in-rush current limiting resistor 203 that is in electrical contact at a first end with power source 17 of handheld computing device 10 and at a second end with radio electronics 18 contained in radio device 13. In an exemplary embodiment, in-rush limiting resistor 203 has a resistance value in the range of 5 to 10 ohms and preferably has a resistance value of approximately 5 ohms. Switch circuit 205 also includes a field effect transistor 207 or other switching device that is in parallel with in-rush current limiting resistor 203. In an exemplary embodiment, field effect transistor 207 is a MOSFET having an “on” resistance in the range of 0.05 to 0.2 ohms and preferably having an “on” resistance of no more than 0.1 ohms. Thus, when field effect transistor 207 is in the “on” state, the resistance across switch circuit 205 is essentially the “on” resistance of field effect transistor 207 and when field effect transistor 207 is in the “off” state, the resistance across switch circuit 205 is essentially the resistance value of in-rush current limiting resistor 203.

Also included in circuit 19 is a time-delay circuit 209 that includes a capacitor 211 that is in electrical contact at a first end with power supply 17 and at a second end with a grounding resistor 213. In an exemplary embodiment, capacitor 211 and resistor 213 are selected so that the R-C time constant of time-delay shorting circuit 209 is approximately equal to the time required for radio electronics 18 (i.e., the input capacitance contained in radio electronics 18) to become gradually charged to a point at or near its normal operating state via the limited current passing through resistor 203 while avoiding a high current in-rush. In an exemplary embodiment, the R-C time constant is in the range of 2-3 milliseconds and preferably 3 milliseconds.

In operation, when power is initially applied to circuit 19 (such as when radio device 13 is inserted into expansion slot 15 of handheld computing device 10), current flows through time-delay shorting circuit 209. The voltage at node 210 is high and biases field effect transistor 207 to the “off” state. With field effect transistor in the “off” state, the impedance across switch circuit 205 is the high resistance value of in-rush current limiting resistor 203. As a result, the otherwise unacceptably high in-rush current into radio electronics 18 is limited to 200 mA, or another selected current as determined by the value of limiting resistor 203.

Once the R-C time constant period has passed (e.g., 3 ms), current stops flowing through time-delay shorting circuit 209. The voltage at node 210 is low and causes field effect transistor 207 to switch to the “on” state. This results in the resistance across switch circuit 205 being the low “on” impedance of field effect transistor 207 (e.g., 0.1 ohms). With field effect transistor 207 in the “on” state, power supply 17 is coupled to the connected radio electronics 18 and provides power for normal operation. The R-C time constant of time delay shorting circuit 209 is selected to limit the in-rush current during initial startup of radio electronics 18 and allow full operation thereafter thereby eliminating the power drain caused by a high initial in-rush current.

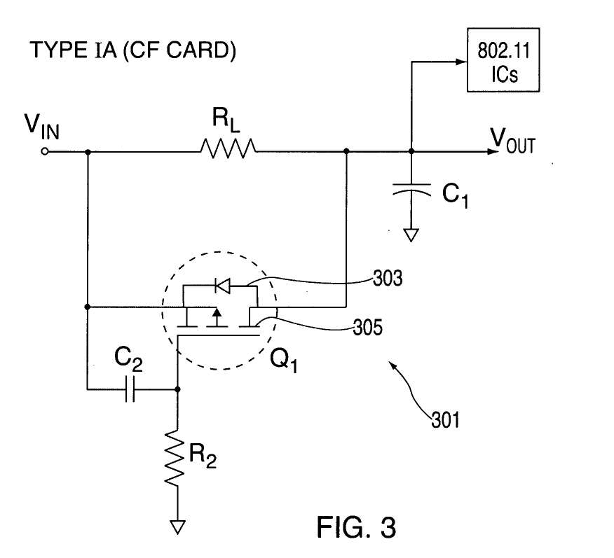

In an exemplary embodiment, other circuits may be used to provide the power management benefits described above including, by way of non-limiting example, circuits that include a current limiting regulator or a transistor pair that function to limit the in-rush current during the power up of radio electronics 18 and circuits that include a switch coupled with either a timer or a sensor for turning off/on the switch at the appropriate time. In an alternative embodiment, the circuit of the present invention may be included in handheld device 10 instead of radio device 13. FIGS. 3-11B are schematics of an in-rush limiting circuit used in the radio device of FIG. 1 in accordance with a alternative embodiments of the present invention.

Referring now to FIG. 3, there is shown a schematic of an in-rush limiting circuit 301 in accordance with a second embodiment of the present invention in which a current-limiting diode 303 is in parallel with a field-effect transistor 305.

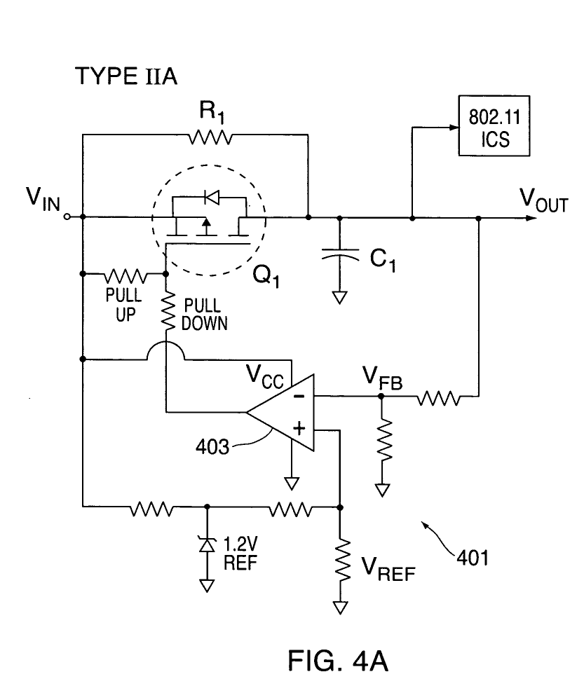

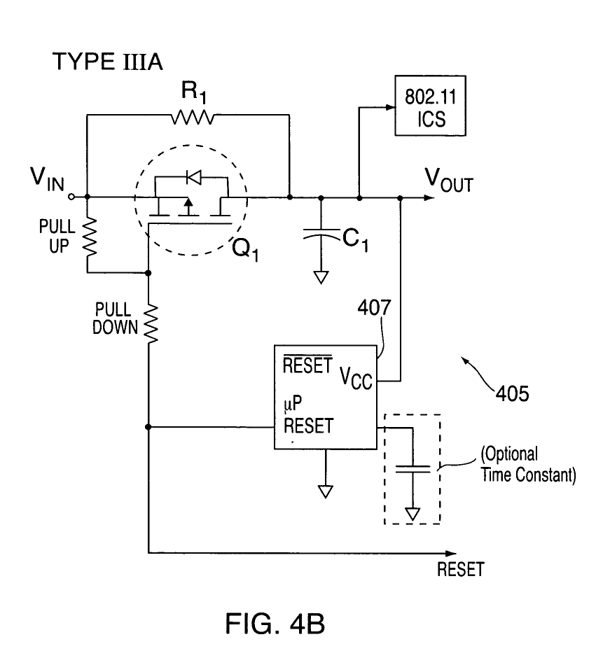

Referring now to FIG. 4A, there is shown a schematic of an in-rush limiting circuit 401 in accordance with a third embodiment of the present invention in which a comparator 403 is used to determine when circuit 401 is to switch from an “off” state to an “on” state.

Referring now to FIG. 4B, there is shown a schematic of an in-rush limiting circuit 405 in accordance with a fourth embodiment of the present invention in which a digital counter 407 is used to determine when circuit 405 is to switch from an “off” state to an “on” state.

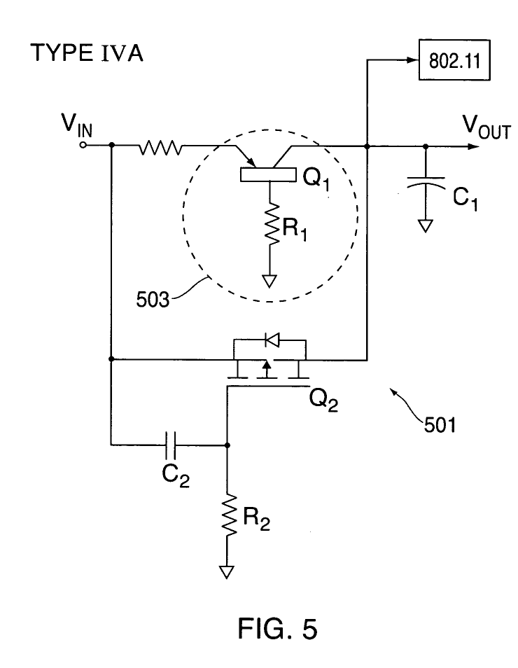

Referring now to FIG. 5, there is shown a schematic of an in-rush limiting circuit 501 in accordance with a fifth embodiment of the present invention that uses as a switching element 503 a voltage controlled resistor, a current regulator diode or a p-channel FET transistor.

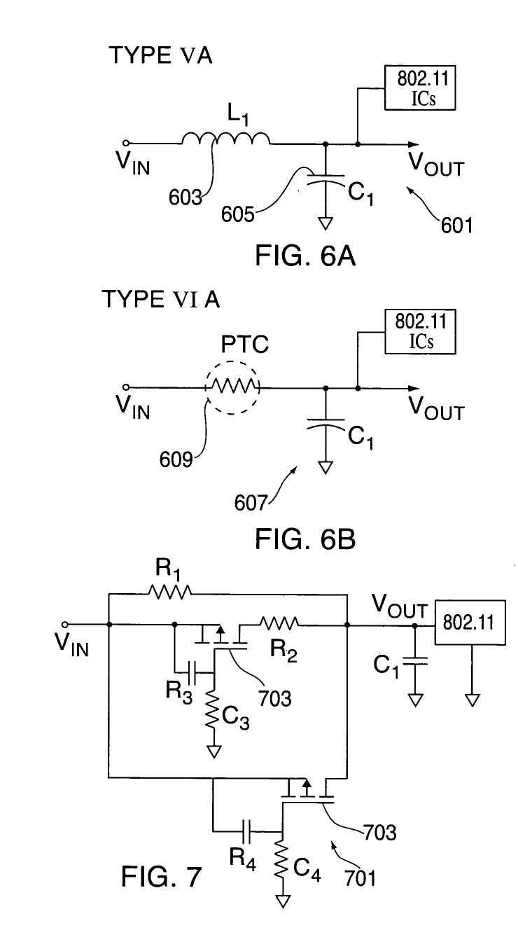

Referring now to FIG. 6A, there is shown a schematic of an in-rush limiting circuit 601 in accordance with a sixth embodiment of the present invention that uses an inductor 603 and capacitor 605 to determine when circuit 601 is to switch from an “off” state to an “on” state.

Referring now to FIG. 6B, there is shown a schematic of an in-rush limiting circuit 607 in accordance with a seventh embodiment of the present invention in which a PTC resettable fuse 609 is used to determine when circuit 607 is to switch from an “off” state to an “on” state.

Referring now to FIG. 7, there is shown a schematic of an in-rush limiting circuit 701 in accordance with a eighth embodiment of the present invention that uses a parallel pair of FET transistors 703 to determine when circuit 701 is to switch from an “off” state to an “on” state.

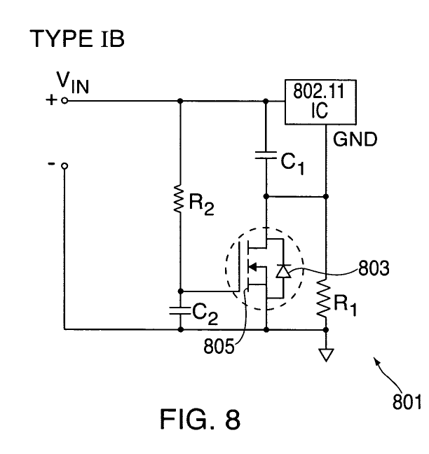

Referring now to FIG. 8, there is shown a schematic of an in-rush limiting circuit 801 in accordance with a ninth embodiment of the present invention in which a current-limiting diode 803 is in parallel with a field-effect transistor 805.

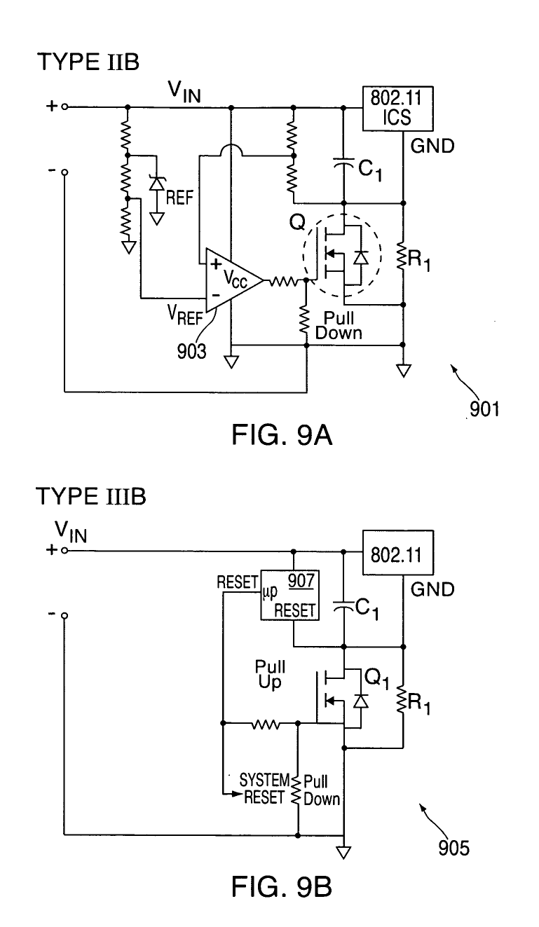

Referring now to FIG. 9A, there is shown a schematic of an in-rush limiting circuit 901 in accordance with a tenth embodiment of the present invention in which a comparator 903 is used to determine when circuit 901 is to switch from an “off” state to an “on” state.

Referring now to FIG. 9B, there is shown a schematic of an in-rush limiting circuit 905 in accordance with a eleventh embodiment of the present invention in which a digital counter 907 is used to determine when circuit 905 is to switch from an “off” state to an “on” state.

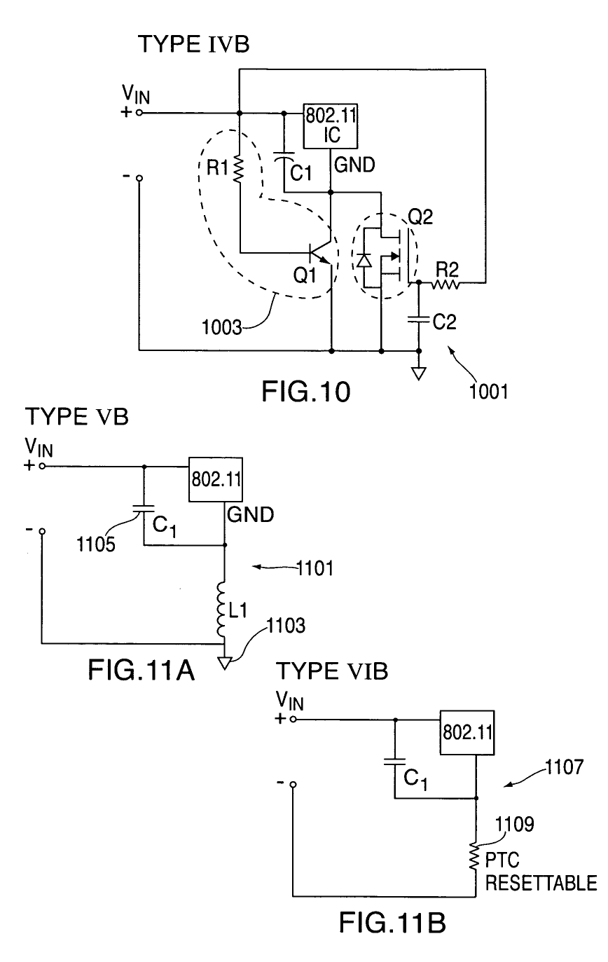

Referring now to FIG. 10, there is shown a schematic of an in-rush limiting circuit 1001 in accordance with a twelfth embodiment of the present invention that uses as a switching element 1003 a voltage controlled resistor, a current regulator diode or an n-channel FET transistor.

Referring now to FIG. 11A, there is shown a schematic of an in-rush limiting circuit 1101 in accordance with a thirteenth embodiment of the present invention that uses an inductor 1103 and capacitor 1105 to determine when circuit 1101 is to switch from an “off” state to an “on” state.

Referring now to FIG. 11B, there is shown a schematic of an in-rush limiting circuit 1107 in accordance with a fourteenth embodiment of the present invention in which a PTC resettable fuse 1109 is used to determine when circuit 1107 is to switch from an “off” state to an “on” state.

Accordingly, a Compact Flash™ radio device is provided that operates according to the power capabilities of low-power handheld computing devices. In particular, an in-rush current limiting circuit is included in the radio device for limiting the current the radio device draws from the power supply of a handheld computing device when the radio device is initially connected to the handheld computing device. Once the radio device is sufficiently charged by the power supply, current to the radio device is no longer limited thereby allowing for normal radio operations. Because the in-rush current limiting circuit of the present invention is small and dissipates little heat, it is suitable for use with radio devices that are provided in a Compact Flash™ or other low power form factor.

A number of embodiments of the present invention have been described. Nevertheless, it will be understood that various modifications may be made without departing from the spirit and scope of the invention.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A circuit for limiting the in-rush current of a radio device coupled to a low-power external power source, comprising:
a switch circuit in series between said power source and said radio device, said switch having an “off” state with a high impedance and an “on” state with a low impedance; and
a time-delay shorting circuit coupled to said switch circuit, said time-delay shorting circuit having a time constant;
wherein before said time constant has elapsed, said switch circuit is in said high impedance “off” state for limiting said in-rush current to said radio device and wherein after said time constant has elapsed, said switch circuit is in said low impedance “on” state so that said radio device is powered by said external power source.

2. In the circuit of claim 1, wherein said switch circuit includes a field effect transistor having an “on” state resistance being in parallel with an in-rush current limiting resistor having a resistance, wherein said high impedance is substantially said resistance of said in-rush current limiting resistor and said low impedance is substantially said on resistance of said field effect transistor.

3. The circuit of claim 2, wherein said “on” state resistance of said field effect transistor is in the range of 0.05 to 0.2 ohms.

4. The circuit of claim 3, wherein said “on” state resistance of said field effect transistor is approximately 0.1 ohms.

5. The circuit of claim 2, wherein said resistance of said in-rush current limiting resistor is in the range of 5 to 10 ohms.

6. The circuit of claim 5, wherein said resistance of said in-rush current limiting resistor is approximately 5 ohms.

7. The circuit of claim 2, wherein said “on” state resistance of said field effect transistor is approximately 0.1 ohms and said resistance of said in-rush current limiting resistor is approximately 5 ohms.

8. The circuit of claim 1, wherein said time constant is in the range of 2 to 3 milliseconds.

9. The circuit of claim 2, wherein said time-delay circuit includes a capacitor and a resistor, said capacitor having a first end coupled to said external power supply and a second end coupled to said field effect transistor and wherein said capacitor has a capacitance and said resistor has a resistance so that said time constant is in the range of 2 to 3 milliseconds.

10. The circuit of claim 1, wherein said radio device is provided in a compact flash form factor and said low-power external power source is provided in a handheld computing device and wherein said radio device is coupled to said handheld computing device.

11. The circuit of claim 1, wherein said circuit is in said radio device.

12. The circuit of claim 1, wherein said circuit is in said power source.

13. A method for limiting the in-rush current of a radio device coupled to a low-power external power source, comprising steps of:
inserting a switch circuit in series between said power source and said radio device, said switch having an “off” state with a high impedance and an “on” state with a low impedance; and
coupling a time-delay shorting circuit to said switch circuit, said time-delay shorting circuit having a time constant;
switching to said high impedance “off” state for limiting said in-rush current to said radio device before said time constant has elapsed; and
switching to said low impedance “on” state after said time constant has elapsed so that said radio device is powered by said external power source.

14. The method of claim 13, wherein said switch circuit includes a field effect transistor having an “on” state resistance in the range of 0.05 to 0.2 ohms, said field effect transistor being in parallel with a in-rush current limiting resistor having a resistance in the range of 5 to 10 ohms, wherein said high impedance is substantially said resistance of said in-rush current limiting resistor and said low impedance is substantially said “on” state resistance of said field effect transistor.

15. The method of claim 14, wherein said “on” state resistance of said field effect transistor is approximately 0.1 ohms and said resistance of said in-rush current limiting resistor is approximately 5 ohms.

16. The method of claim 13, wherein said time constant is in the range of 2 to 3 milliseconds.

17. The method of claim 14, wherein said time-delay circuit includes a capacitor and a resistor, said capacitor having a first end coupled to said external power supply and a second end coupled to said field effect transistor and wherein said capacitor has a capacitance and said resistor has a resistance so that said time constant is in the range of 2 to 3 milliseconds.

18. The method of claim 13, wherein said radio device is provided in a compact flash form factor and said low-power external power source is provided in a handheld computing device and wherein said radio device is coupled to said handheld computing device.

19. The method of claim 13, further comprising the step of”
placing said switch circuit and said time-delay shorting circuit in said radio device.

20. The method of claim 13, further comprising the step of”
placing said switch circuit and said time-delay shorting circuit in said power supply.

21. A radio device provided in a compact flash form factor, said radio device being powered by a low-power external power source, comprising:
radio electronics having an in-rush current demand;
a switch circuit in series between said power source and said radio device, said switch circuit having an “off” state with a high impedance and an “on” state with a low impedance; and
a time-delay shorting circuit coupled to said switch circuit, said time-delay shorting circuit having a time constant;
wherein before said time constant has elapsed, said switch circuit is in said high impedance “off” state for limiting said in-rush current to said radio device and wherein after said time constant has elapsed, said switch circuit is in said low impedance “on” state so that said radio device is powered by said external power source.

22. The radio device of claim 21, wherein said switch circuit includes a field effect transistor having an “on” state resistance in the range of 0.05 to 0.2 ohms, said field effect transistor being in parallel with a in-rush current limiting resistor having a resistance in the range of 5 to 10 ohms, wherein said high impedance is substantially said resistance of said in-rush current limiting resistor and said low impedance is substantially said “on” state resistance of said field effect transistor.

23. The radio device of claim 22, wherein said “on” state resistance of said field effect transistor is approximately 0.1 ohms and said resistance of said resistor is approximately 5 ohms.

24. The radio device of claim 22, wherein said time-delay circuit includes a capacitor and a resistor, said capacitor having a first end coupled to said external power supply and a second end coupled to said field effect transistor and wherein said capacitor has a capacitance and said resistor has a resistance so that said time constant is in the range of 2 to 3 milliseconds.

25. A method for limiting the in-rush current of a radio device coupled to a low-power external power source, comprising the steps of:
initially charging the radio device with a power source in a low power state;
sensing a voltage across a component associated with said radio device; and
switching from said low power state to a full power state when said voltage exceeds a threshold level.

26. A low power radio device, comprising:
radio electronics,
means for limiting the in-rush current of said radio electronics upon initial powering of said radio electronics.

27. The device of claim 26, wherein the means for limiting comprises a limiting resistor.

28. The device of claim 26, wherein the means for limiting comprises an RC circuit.

29. The device of claim 26, wherein the means for limiting comprises an LC circuit.

30. The device of claim 26, wherein the means for limiting comprises a voltage sensitive switch.

31. The device of claim 26, wherein the means for limiting comprises comparator.

32. The device of claim 26, wherein the means for limiting comprises a digital counter.

33. The device of claim 26, wherein the means for limiting comprises an RC circuit.

34. The device of claim 26, wherein the means for limiting comprises a current limiting diode in parallel with a field effect transistor.

35. The device of claim 26, wherein the means for limiting comprises a voltage controlled resistor.

36. The device of claim 26, wherein the means for limiting comprises a current regulator diode.

37. The device of claim 26, wherein the means for limiting comprises a PTC resettable fuse.
